(19) United States
(12) Patent Application Publication
(10) Pub. No.: US 2006/0065371 A1
(43) Pub. Date: Mar. 30, 2006

(54) Automatic labeling machine for containers

(75) Inventors: Henry Grabowski, Bel Air, MD (US); Rafael Santiago, Lancaster, PA (US); Eugene E. Baldwin JR., Landisville, PA (US); Gene E. Walter, Columbia, PA (US); Troy D. Shepro, Lancaster, PA (US); Harry D. Hotchkiss, Willow Street, PA (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(73) Assignee: J.L. Clark, Inc., Rockford, IL (US)

(21) Appl. No.: 10/953,251

(22) Filed: Sep. 29, 2004

(51) Int. Cl. B65C 9/18; B65C 9/26

(52) U.S. Cl. 156/538; 156/542; 156/556

(57) ABSTRACT

The packaging machine applies labels to multiple sides of containers in an automated fashion. The machine comprises a magnetic conveyor extending along a predetermined path. Along the conveyor in sequence are an upstream label dispensing station, an upstream press station, an intermediate turner station, a downstream label dispensing station, and a downstream press station. The turning station reorients containers carried on the conveyor such that labels may be applied to multiple different sides of a container in an automated fashion.

### FIELD OF THE INVENTION

The present invention generally pertains to apparatus for applying labels and more particularly applies to packaging machines which apply labels to multiple sides of containers in which containers are conveyed through multiple stations for automatic labeling processes.

### BACKGROUND OF THE INVENTION

In the container industry it is often desirable to apply labels to containers for a wide variety of purposes such as providing product information for consumers and/or for securing different container components together to prevent a container from falling apart and for tamper resistance. Although such labeling can be done manually, it is desirable to avoid labor intensive manual labeling for cost reasons and for purposes of economy. Automated processes also provide the potential for higher production rates, that is of course if satisfactory and reliable labeling can be done automatically. Such labels may be made from plastics, vinyls, paper materials, and/or other materials (which may either be transparent or solid) in which the labels are adhesively attached to a release liner strip. The labels and release liner are typically wound into a roll of stock material. The present invention provides a significant innovation as it relates to the automated labeling of containers.

### BRIEF SUMMARY OF THE INVENTION

The present invention provides a packaging machine for applying labels to multiple sides of containers in an automated fashion. The machine comprises a conveyor extending along a predetermined path. Along the conveyor is a first label dispensing station that is adapted to place labels on first opposing sides of containers that are conveyed on the conveyor. A first press station is arranged downstream of the first label dispensing station. The press station includes press rolls that are adapted to engage opposing sides of the container. The press rolls are movable toward and away from the conveyor. The press rolls have an outer surface that is complimentary to the outer surface of container so that the press rolls will engage the container over a wide area and more securely apply the stickers on the container. The packaging machine also includes a turner station which is disposed downstream of the first press station and label dispensing station. The turner station includes a rotary actuator, a vertical actuator and a pick head which are operationally configured in order to reorient the containers on the conveyor to expose different sides of the container for receipt of labels. Downstream of the turner station is a further label dispensing station and a further press station which may be similar to the first label dispensing and press stations upstream of the turner station, except that these downstream stations apply labels to different sides of the container.

Other aspects, objectives and advantages of the invention will become more apparent from the following detailed description when taken in conjunction with the accompanying drawings.

### BRIEF DESCRIPTION OF THE DRAWINGS

FIG. 1 is a partly schematic perspective view of a automatic labeling machine for applying labels to containers in accordance with a preferred embodiment of the present invention.

FIG. 2 is a view similar to FIG. 1 except showing a different operational stage.

FIG. 3 is an enlarged partly schematic view of a label dispensing station and a press station (only one side being shown).

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

For purposes of illustration, a preferred embodiment of the present invention has been depicted as an automatic labeling machine 10 for applying labels 12 to different sides of containers 14. In this machine, the containers are rectangular or square metal two-piece tins including a cover and a base in which labels 12 are applied to four different sides of the container. However, it will be understood that different shapes, sizes and configurations of containers with fewer or more sides can be subject to the invention disclosed herein.

The labeling machine 10 includes a conveyor 16 that extends through multiple different operational stations between a container inlet 18 and an outlet 20. The conveyor may be broken up into multiple sections or conveyor belts 22 as shown, which may be independently movable and controlled by an electronic controller 24 such as a programmable logic device (PLC) or alternatively a microprocessor or other similar controller. Preferably, the conveyor belts 22 may be independently driven and controlled through the electronic controller with a constant speed (and equal speed among conveyor sections). However, the conveyors may be driven at a variable speed. In any event, the conveyor 16 transports the containers 14 through the multiple stations along a predetermined path between the inlet 18 and the outlet 20. In the disclosed embodiment, the belts 22 of the conveyors are magnetic to secure and maintain the positions of the metal containers 14 when they are centrally located and aligned on the conveyor 16.

Disposed along the conveyor are multiple different stations which are arranged in a predetermined sequence along the conveyor path. The stations include an upstream label dispensing station 26, an upstream press station 28, a turner station 30, a downstream label dispensing station 32, and a downstream press station 34. At the upstream label dispensing station 26, labels 12 are applied to two opposing sides of the containers 14. The labels 12 may either be transparent (e.g. if the desired function is only to secure the tin sections of the container together and/or for tamper resistance) and/or may be solid to include a printed indicia thereon to provide for advertising, product information, barcode, and/or price information and the like. Preferably, the labels 12 include an adhesive which releasably secures the labels 12 to a release liner 36. Typically the labels and release liner would be wound up into stock material rolls which are ready to be unwound to allow the labels to be readily dispensed and applied to containers 14 as is shown.

The upstream press station 28 more securely fastens the labels 12 to opposing sides of the containers by firmly pressing the adhesive labels 12 against the sides of the container. A turner station 30 operates to turn and rotate the conveyors to a new angular orientation, in this case 90 degrees according to a preferred embodiment. Once the containers 14 are rotated, they proceed through a further downstream label dispensing station 32 and then a further downstream press station 34 which apply additional labels to additional sides of the containers. In this case, the downstream label dispensing and press stations 32, 34 apply labels to different container sides as opposed to the upstream label dispensing and press stations 26, 28.

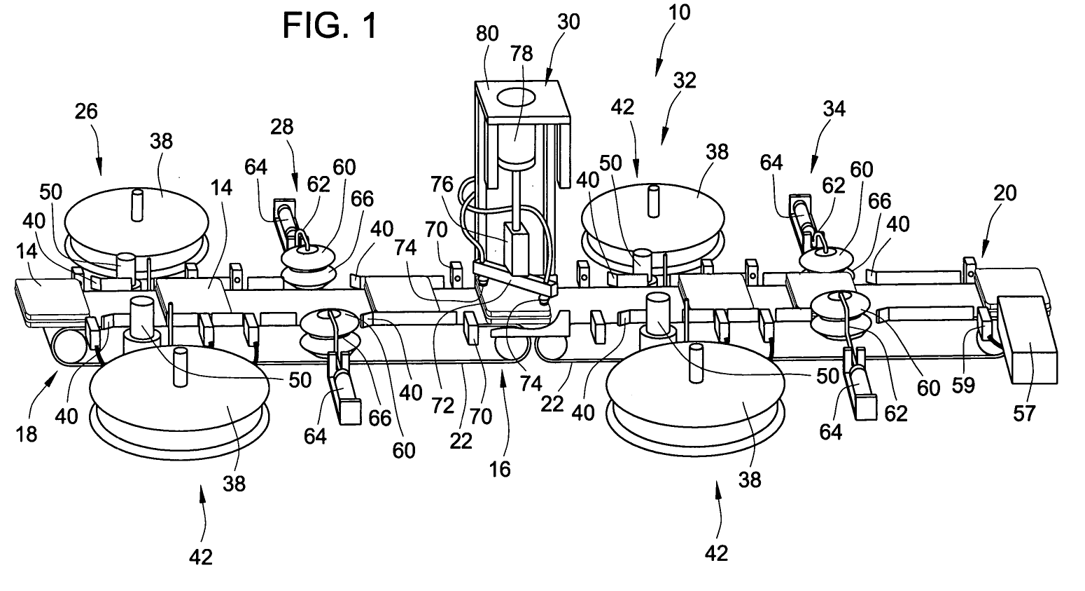

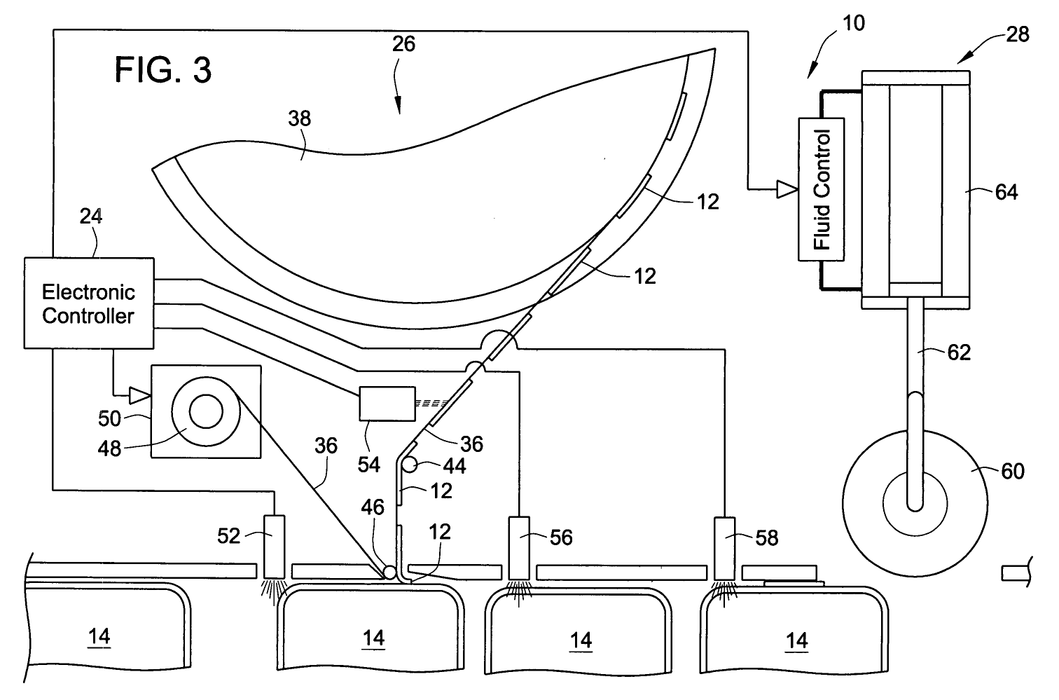

Turning in greater detail to a label dispensing station 26, additional reference can be had to FIGS. 1 and 3 in which FIG. 3 shows the label dispensing station 26 and press station 28 on one side of the conveyor 16. It will be understood that the other half of the label dispensing station and press station on the other side of the conveyor is substantially the same and also that the assemblies for the downstream label dispensing and press stations 32, 34 include the same components and operate in a similar manner.

Prior to entering the label dispensing station 26, preferably guide means is provided such as the pair of inwardly directed guides 40 which if engaged by a container 14 will redirect and re-center the container 14 on the conveyor 16. Once redirected, the magnetic force on the belts of the conveyor maintain the centrally located position thereon. These guides 40 may take the form of plates and/or rails which are placed on opposing sides of the conveyor 16 in order to cooperate with one another to guide and center the containers 14. Additionally, similar guides 40 may also be placed at other strategic locations along the conveyor 16 as indicated where it is desired to precisely locate and center the container 14 to facilitate either a labeling operation and/or a turning operation.

In any event, once a centered container 14 enters the label dispensing station 26, it is fed through a label dispenser 42. The label dispenser 42 in shown in greater detail in FIG. 3. With reference to this figure, the lead off of the stock material roll 38 is fed around a pair of guide posts 44, 46, the second of which causes the lead to substantially reverse direction very quickly which in turn causes labels 12 carried on the release liner 36 (which are attached at spaced intervals) to automatically detach with the adhesive backing showing. This adhesive backing is picked up by the side of the container 14 and thereby adhesively connects thereto as the containers 14 are transported along the conveyor 16.

The speed and operation of the label dispenser 42 is controlled via the electronic controller 24 (there may be single unitary controller which controls all operations or there may be separate controllers for each independent mechanism, which may be in communication with one another). The electronic controller 24 controls a drive motor 48 that rotates the liner collection reel 50 to which the lead of the waste liner in attached. In this manner, operation of the drive motor 48 is operational to pull the label material from the stock material roll and around the guide posts 44, 46 in order to dispense labels 12 from the release liner 36.

A first proximity sensor 52 immediately upstream of where labels are dispensed at guide post 46. the proximity sensor 52 provides feedback to the electronic controller 24 when a container is sensed, which triggers operation of the drive motor 48 to operate the label dispenser 42. The speed at which the label material from the stock material is pulled corresponds to the same speed as that of the conveyor 16 so as to uniformly apply labels 12 over the side length of the containers 14. In other words, the label dispensing machine 42 operates at a substantially equal speed to that of the conveyor. The operation of the label dispensing machine 42 is intermittent in that after activation of the drive motor 48 is activated by virtue of being triggered by the proximity sensor 52 (with or without a delay), the drive motor 48 is then stopped. A second sensor in the form of a scanner or register sensor 54 is arranged in operative communication with the release liner 36 and/or labels 12 to read register markings which are at spaced intervals along the stock material held on the roll 48 equivalent to the spacing between labels 12 along the release liner 36. Each time the register sensor 54 reads such a registration mark on the liner 36, it generates feedback to the electronic controller 24 which triggers stoppage of the drive motor 48 and thereby stoppage of the label dispenser 42. The drive motor 48 is then stopped until the next container 14 is sensed by the first proximity sensor 52 which restarts the process and again triggers the activation of the label dispenser 42.

Immediately downstream of the location at which labels are dispensed is a further sensor in the form of a label reader 56 and in this case a clear label reader which is operative to sense the presence of labels 12 on opposing sides of the containers 14. The label reader 56 provides further communication to the electronic controller 24 and provides an indication as to the presence or absence or a properly applied label 12 to the side of the container 14. When a properly applied label is sensed, no action is required and the container 14 can proceed through the system. If, however, the label sensor 56 senses the absence or an improperly applied label 12, then that container 14 is registered (and kept track of by virtue of a count generated by various proximity sensors in the system which allows the controller 24 to maintain a count and thereby facilitate a way of tracking individual containers along the conveyor). At the end port outlet 20 of the automatic label dispensing machine, the defective container 14 would then be removed such as by being blown off or otherwise removed by any other appropriate removal mechanism 57 (with a proximity sensor 59 immediately upstream thereof to initiate activation of such a mechanism).

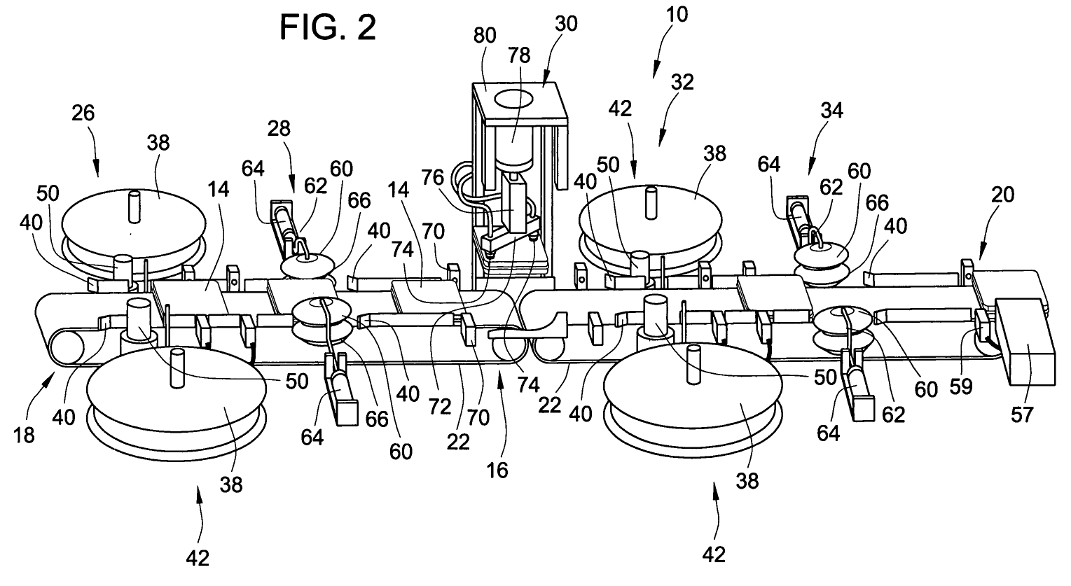

Although one label dispenser 42 is shown in FIG. 3, it will be understood that the four different label dispensers depicted in FIGS. 1 and 2 are substantially identical except for their relative locations on opposing sides of the conveyor and the upstream or downstream locations of the label dispenser. In any event, all the different label dispensers operate in a similar manner as that described above.

Once a label has been applied, then the containers 14 will enter the press station 28 or 34 which is immediately downstream of the label dispensing station 26 or 32. At the press station, a proximity sensor 58 is located immediately upstream of press rolls 60. Each press roll 60 is carried by a horizontally extending arm 62 which is connected to a pneumatic cylinder 64 or other appropriate linear actuator. The pneumatic actuator 64 is operative to drive the arm 62 and press roll 60 horizontally inwardly and outwardly relative to the conveyor 16. Operation of the pneumatic cylinder 64 is controlled by the electronic controller 24 that is operable to control solenoid valves to the pneumatic cylinder via known fluid power techniques (or alternatively drive an electrical actuator). The press roll 60 includes a contoured inner surface 66 that is complimentary to the side profile of the container 16. In this manner, when the press roll 60 is driven into engagement with the container 14, the press roll closely matches and hugs the outer side of the container 14 so as to press and more firmly secure the labels 12 on the sides of the container 14. Because different press rolls 16 work in tandem on opposing sides of the containers 14 the press rolls can apply a compressive force to the sides of the container on opposing sides of the containers 14. Operation of the press roll 60 is triggered by the proximity sensor 58. Once triggered, the press roll 60 is maintained in the engaged position for a predetermined time which corresponds to the known or sensed speed of the conveyor 16 so that the press roll 60 will engage substantially the entire length of the labels 12 over the sides of the containers 14. The press rolls are then retracted to permit advance of another container.

Although only one press roll 60 and associated components is shown in FIG. 3 and described above, it will be understood that two press rolls and associated components are provided at each different press station and that the press rolls and their components differ only in the location by being either upstream or downstream and on either side of the conveyor. It is also readily evident upon viewing FIGS. 1 and 2 that pairs of press rolls 60 and pneumatic cylinders 64 work in cooperation with each other on opposing sides of containers 14.

Operation of the turner station 30 may likewise be timed in sequence with the conveyor 16 and can triggered (with or without an appropriate time delay) by a proximity sensor 70 located immediately upstream of a turn mechanism which forms the primary component of the turner station 30. The turner mechanism includes a pick head 72 which includes means for releasably picking and supporting containers off of the conveyor. In this case, the support means comprises suction or vacuum cups 74 which are subject to pneumatic vacuum pressure (the vacuum is turned on to pick a container and off to release the container). However, other means may be also provided such as a magnetic pick head or other dripping mechanism. The pick head 72 is carried by a vertical actuator which may take the form of a pneumatic linear cylinder 76 and a rotary actuator which may take the form of a rotary pneumatic cylinder 78. In the disclosed embodiment, the rotary pneumatic cylinder 78 carries the linear pneumatic cylinder 76 although the two may be reversed such that the linear actuator carries the rotary actuator. The rotary pneumatic cylinder 78 is carried by a stationary support form 80 that extends up above and over the top of the conveyor mechanism 16. The frame 80 may be mounted to the primary support base or frame for the entire automatic labeling machine 10.

The operation of the turner station is as follows. First, the ordinary ready position for the turner station is with the linear pneumatic cylinder 74 in the retracted up position to provide clearance for receiving a new container 14 into the turner station 30. Once a container 14 is sensed by the proximity sensor 70, the proximity sensor 70 generates feedback to the electronic controller 24 which triggers activation of the linear pneumatic cylinder 76 that drops the pick head 72 down upon the container 14. The pick head 72 is also active at this time in order to provide sufficient suction in order to pick a container 14 from the conveyor 16. Once the pick head 72 picks a container 14, the linear pneumatic cylinder 76 is then retracted to lift the container 14 from the conveyor. Then the rotary pneumatic cylinder 70 is activated to rotate the container 14 in order to reorient the angular position of the container 14, which in this case is 90° although other different angular reorientations are possible. Then a linear pneumatic cylinder 76 drops and places the container 14 back onto the conveyor in the reoriented position. Thereafter, the pick head 72 is deactivated to release the suction and thereby release the container 14 to the conveyor 16. The linear actuator is again raised (then the rotary actuator may be rotated back to the receive position if desired or can stay in the same orientation in the case of a stepper type motor). By facilitating reorientation in a 90° turn of the containers 14, a different side of the container 14 is then presented to the downstream label dispensing station 32 and press station 34 for purposes of labeling different sides of the container.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A packaging machine for applying labels to containers, comprising:
a conveyor extending along a predetermined path;
a first label dispensing station along the conveyor adapted to place the labels on first opposing sides of the containers;
a first press station downstream of the first label dispensing station along the conveyor, the first press station comprising a first pair of press rolls, the first pair of press rolls on opposing sides of the conveyor and being movable toward and away from the conveyor, the press rolls having an outer surface complimentary to the containers for contact therewith for applying labels securely on the containers;
a turner station along the conveyor downstream of the first press station, the turner station including a rotary actuator and a vertical actuator which carry a pick head, the pick head adapted to pick containers from the conveyor, the pick head being operational actuated by the rotary and vertical actuators for changing an angular orientation of the containers;
a second label dispensing station along the conveyor adapted to place the labels on second opposing sides of the containers; and
a second press station downstream of the second label dispensing station along the conveyor, the second press station comprising a second pair of press rolls, the second pair of press rolls on opposing sides of the conveyor and being movable toward and away from the conveyor, the press rolls having an outer surface complimentary to the containers for contact therewith for applying labels securely on the containers.

2. The packaging machine of claim 1, wherein the conveyor comprises first and second conveyor belts extending along a linear path in end to end relation and meeting at the turner station.

3. The packaging machine of claim 1, wherein each press station includes linear actuators, each linear actuator driving one of the press rolls toward and away from the conveyor, and wherein the conveyor is narrower than a corresponding width of the containers.

4. The packaging machine of claim 1, further comprising guide means located upstream of the first and second label dispensing stations for centering the containers when conveyed on the conveyor.

5. The packaging machine of claim 4, further comprising second guide means located immediately downstream of the first press station for centering the containers when conveyed on the conveyor.

6. The packaging machine of claim 1, wherein each label dispensing station comprises a pair of label stock rolls, each label stock roll being comprised of a coiled media strip comprising plurality of labels carried on a release liner, the strip of each label stock roll being guided toward conveyor and around a release bar and then away from the conveyor.

7. The packaging machine of claim 1, further comprising sensing means upstream of the each label dispensing stations for triggering when the label dispensing stations dispense labels onto the containers in response to sensing containers on the conveyor.

8. The packaging machine of claim 7, wherein each press station includes linear actuators, each linear actuator driving one of the press rolls toward and away from the conveyor, and wherein the conveyor is narrower than a corresponding width of the containers, further comprising second sensing means immediately upstream of each of the press stations for controlling the driving movement of each linear actuator.

9. The packaging machine of claim 1, wherein the pick head comprises a vacuum cup mechanism adapted to apply suction to tops of containers, the pick head being carried by a pneumatic actuator, the vertical pneumatic actuator being mounted to a support frame that extends above the conveyor.

10. The packaging machine of claim 1, further comprising means for detecting presence of labels on the containers.
